(19) United States
(12) Patent Application Publication
(10) Pub. No.: US 2008/0125883 A1
(43) Pub. Date: May 29, 2008

(54) Method and apparatus for consolidating process control

(76) Inventors: Christopher Gould, Quinton, VA (US); Thomas Fisher, Sandston, VA (US); Abeer Singhal, Richmond, VA (US)

Correspondence Address: EDELL, SHAPIRO & FINNAN, LLC, 1901 RESEARCH BLVD., SUITE 400, ROCKVILLE, MD, 20850, US

(21) Appl. No.: 11/518,230

(22) Filed: Sep. 11, 2006

(51) Int. Cl. G05B 13/02

(52) U.S. Cl. 700/51

(57) ABSTRACT

The present invention embodiments consolidate process control for a process including a plurality of control threads each associated with a stage of the process. A plurality of the control threads are analyzed to enable the process control with a reduced quantity of the control threads. Data associated with the plurality of control threads are validated and provided in a desired form. At least one parameter of each of the plurality of control threads is statistically analyzed to form at least one thread group including a plurality of the control threads satisfying the parameter analysis. Each thread group functions as a common thread to enable the process control with a reduced quantity of control threads. The present invention embodiments further include a method and program product apparatus for consolidating the process control.

### BACKGROUND OF THE INVENTION

1. Technical Field

The present invention pertains to process control. In particular, the present invention pertains to monitoring process controllers of a semiconductor fabrication process and dynamically organizing the process controllers based on a model/rule schema to consolidate process control (e.g., reduce the quantity of control loops or process controllers within the fabrication process).

2. Discussion of the Related Art

Current highly modernized semiconductor manufacturing facilities rely on simple closed loop control systems for process optimization and improved process capability. The changing consumer trend and subsequent product development is pushing fabrication facilities to be flexible in order to adapt to a high part mix scenario. This type of scenario encompasses fabrication of products and/or parts of different technology nodes (e.g., varying smallest critical dimensions on a chip, such as 110 nm, 90 nm, 65 nm, etc.) and product design (e.g., Memory, logic, RFID, etc.). A high part mix scenario in combination with high volume manufacturing necessitates metrology sampling to meet cycle time goals, capital costs and floor space constraints.

Semiconductor fabrication facilities generally employ a Run-to-Run (R2R) type control scheme with a Statistical Process Control (SPC) system for process control. The Run-to-Run control employs a feedback loop to control fabrication from wafer to wafer (e.g., after each run of the particular fabrication process). Each controller within the Run-to-Run system controls a corresponding process or stage of fabrication and is mutually exclusive with respect to other controllers. In other words, each controller operates independently and does not learn from other process controllers, while the process controllers are generally inflexible and cannot easily adapt to new fabrication processes or products.

The Statistical Process Control (SPC) system basically serves as a monitoring system to provide information to system operators (e.g., in the form of charts, etc.). The Run-to- Run control system along with Statistical Process Control (SPC) provides for a robust control package. For example, under these operating conditions, a manufacturing facility is able to handle a high part mix scenario by initializing process controllers.

Generally, as new manufacturing processes, products and/or parts are introduced into the fabrication (e.g., high part mix scenarios including products or parts diversified in technology nodes and/or product design), additional control loops and/or process controllers are needed for fabrication in order to control further process stages that account for the various items. For example, a high part mix scenario and sampling tends to require a large quantity of control loops and/or process controllers (e.g., the quantity of control loops typically undergoes a multiplication effect). Since this increases costs and complexity of fabrication, fabrication control systems constrained by a high part mix scenario and sampling typically require a reduction in the quantity of control loops needed to be optimized and monitored during fabrication.

Accordingly, the related art has attempted to reduce or consolidate the control loops by optimizing the control models which govern the process controllers based on the corresponding processing step or stage. However, these models require higher sampling and/or manual grouping of process controllers (e.g., common control loops for one or more processes or stages). The manual grouping schemes for the process controllers are generally cumbersome to maintain and inaccurate over time, while sampling reduces the accuracy of predicted process settings.

Another approach of the related art employs mathematical models alongside Run-to-Run control to minimize the effects of a Run-to-Run process controller and return that controller to a state producing satisfactory results for successive wafers or runs. Although the grouping schemes for process controllers in this scenario have been shown as viable solutions, the groupings are performed manually and suffer from disadvantages similar to those described above.

### SUMMARY OF THE INVENTION

According to an embodiment of the present invention, a system consolidates process control for a process including a plurality of control threads each associated with a stage of the process. The system includes a processing system to analyze a plurality of the control threads to enable the process control with a reduced quantity of the control threads. The processing system includes a data analysis module to validate data associated with the plurality of control threads and to provide the data in a desired form, and a group analysis module to statistically analyze at least one parameter of each of the plurality of control threads and to form at least one thread group including a plurality of the control threads satisfying the parameter analysis. Each thread group functions as a common thread to enable the process control with a reduced quantity of control threads. The present invention embodiments further include a method and program product apparatus for consolidating the process control as described above.

The above and still further features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1A is a block diagram of an exemplary fabrication system employing the process control according to an embodiment of the present invention.

FIG. 1B is a block diagram of the Run-to-Run control system and process cell of the system of FIG. 1A.

FIG. 2 is a procedural flow chart illustrating the manner in which control loops or process controllers are grouped according to an embodiment of the present invention.

FIG. 3 is a diagrammatic illustration of an exemplary grouping of control loops or process controllers in the manner illustrated in FIG. 2.

### DETAILED DESCRIPTION OF THE PREFERRED EMBODIMENTS

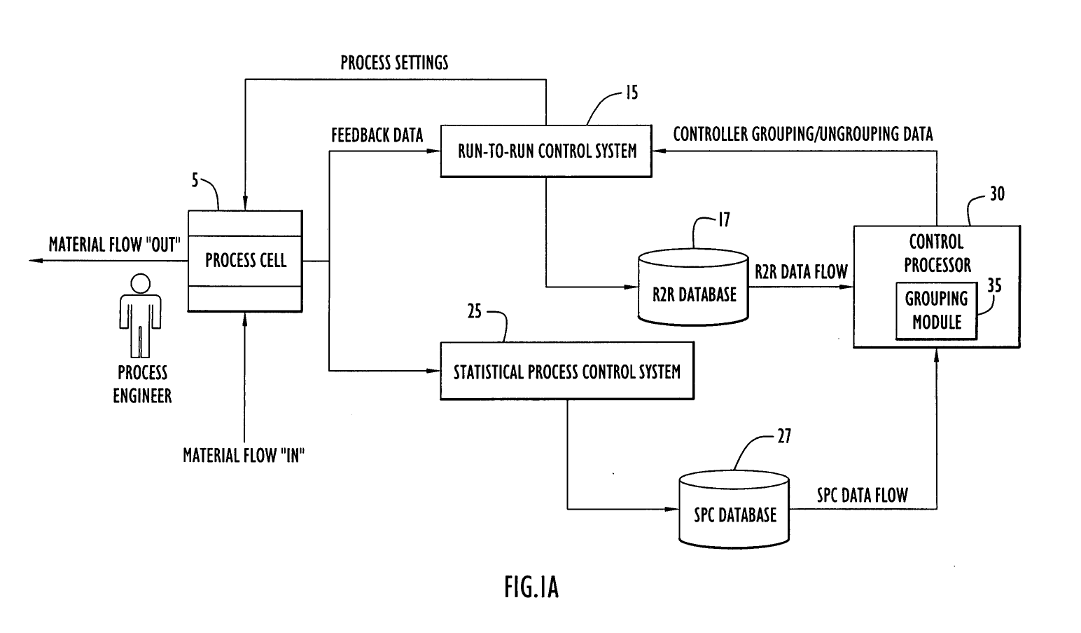

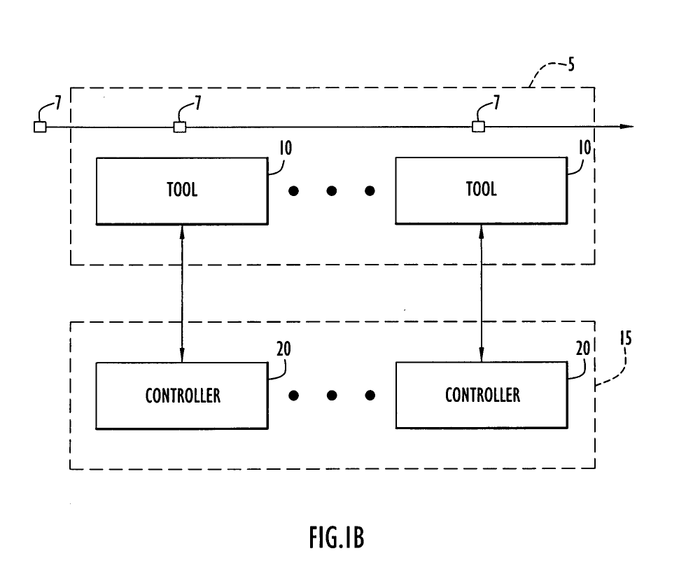

The present invention embodiments pertain to monitoring process controllers of a semiconductor fabrication process and dynamically organizing (e.g., grouping and/or ungrouping) the process controllers based on a model/rule schema to consolidate process control (e.g., reduce the quantity of control loops within the fabrication process). An exemplary fabrication system 100 employing process control according to an embodiment of the present invention is illustrated in FIGS. 1A-1B. Initially, the fabrication system performs a fabrication process to fabricate an object 7 (e.g., semiconductor wafer or other component), wherein the process typically includes one or more stages each associated with a specific fabrication task to be performed on the object. Specifically, the fabrication system includes one or more process cells 5, a conventional Run-to-Run control system 15, a conventional Statistical Process Control (SPC) system 25 and a control processor 30.

Process cell 5 receives materials or objects 7 and performs specific tasks on the objects (e.g., semiconductor wafer or other component) associated with process stages. The process cell is controlled by Run-to-Run control system 15 that utilizes a feedback or control loop to generate controls (e.g., Process Settings as viewed in FIG. 1A) in order to control the process cell for each of successive objects 7 (e.g., after each run of the particular fabrication process) as described below. The resulting controls generated by control system 15 are based on process models that are being continuously improved in accordance with measured characteristics (e.g., contained within the FeedBack Data as viewed in FIG. 1A) to achieve tighter control. Run-to-Run control system 15 collects information (e.g., feedback information, generated controls, etc.) during the fabrication for storage in a database 17. The feedback information is further provided to Statistical Process Control (SPC) system 25 to enable that system to monitor the fabrication (e.g., monitor process conformance and capability) and provide information to system operators (e.g., in the form of charts, etc.). Statistical Process Control (SPC) system 25 collects the information for storage in a database 27. Databases 17, 27 may be implemented by any conventional or other database or storage structure or unit (e.g., file system, memory, data structure, etc.). The recorded data is updated regularly in order for the Statistical Process Control (SPC) system to monitor the fabrication.

Control processor 30 is coupled to databases 17, 27 and/or control systems 15, 25 and retrieves information from those databases and/or systems to perform the grouping analysis according to the present invention embodiments as described below. The results of the grouping analysis (e.g., Controller Grouping/Ungrouping data as viewed in FIG. 1A) are provided to Run-to-Run control system 15 to enable process controllers 20 (FIG. 1B) within that system to be grouped and/or ungrouped according to the results as described below. Control processor 30 may be implemented by any conventional or other controller or processing system (e.g., controller, microprocessor, etc.).

Process cell 5 receives materials or objects 7 and performs specific tasks on the objects (e.g., semiconductor wafer or other component) associated with process stages as described above. The process cell includes one or more tools 10 (FIG. 1B) that each perform a specific task on the objects (e.g., semiconductor wafer or other component) associated with a process stage. Run-to-Run control system 15 includes one or more process controllers 20 each controlling an associated tool 10 to perform a process stage task on objects 7 (e.g., semiconductor wafer or other component). In other words, the controllers control the tool or tool settings for performance of the fabrication process stages and/or regulation of object characteristics resulting from the performance of those stages (e.g., object critical dimensions, tool focus, overlay, object thickness, chemicals, lithography, etc.). The objects traverse each tool or process stage (e.g., as indicated by the arrow in FIG. 1B) during fabrication to produce a final product from process cell 5. Controllers 20 may be implemented by any conventional or other controller or processing device (e.g., controller, microprocessor, etc.).

Run-to-Run control system 15 utilizes a feedback or control loop to generate process settings for the process cell tools as described above. In particular, each controller 20 utilizes a feedback or control loop to control an associated tool 10 for each of successive objects 7 (e.g., after each run of the particular fabrication process). Various sensors (not shown) may be employed with each tool 10 of process cell 5 to measure object or tool characteristics. The measured characteristics and/or other information are provided to the corresponding controller within Run-to-Run control system 15 (e.g., FeedBack Data as viewed in FIG. 1A) to determine subsequent controls (e.g., Process Settings as viewed in FIG. 1A) for the tool based on the measured characteristics. For example, a controller 20 may adjust tool settings or parameters based on the measured values to compensate for variances in object characteristics and/or tool operation. The resulting controls generated by controllers 20 are based on process models that are being continuously improved based on the measured values to achieve tighter control. The measured values, generated controls and/or other information (e.g., parameters, models, etc.) may be stored by the Run-to-Run control system in database 17. In addition, the measured characteristics and/or other information are provided to Statistical Process Control (SPC) system 25 to monitor the fabrication system (e.g., monitor process conformance and capability) and provide information to system operators (e.g., in the form of charts, etc.). This information may be stored in database 27 and is updated regularly in order for the Statistical Process Control (SPC) system to monitor the fabrication.

Generally, as new manufacturing processes, products and/or parts are introduced into the fabrication (e.g., high part mix scenarios including products or parts diversified in technology nodes and/or product design), additional control loops and/or controllers 20 are needed for the fabrication in order to control further process stages that account for the various items. For example, a high part mix scenario tends to require a large quantity of control loops and/or process controllers (e.g., the quantity of control loops typically undergoes a multiplication effect), thereby increasing costs and complexity of fabrication.

The present invention embodiments reduce the number of control loops required to be monitored and optimized by Run-to-Run control system 15 and Statistical Process Control (SPC) system 25. The reduction in control loops is achieved by grouping together similar process controllers 20. These grouped controllers operate based on (or share) a common control loop (as opposed to each process controller operating based on a different control loop), where the process controllers within the group may concurrently learn or be trained in the desired process. Thus, the present invention embodiments enable the fabrication process to be performed with a reduced quantity of control loops (and, hence, process controllers).

The compression or consolidation of control loops and smart grouping of process controllers are based on real time statistical data and/or a defined rule scheme. The information required for the compression and grouping is obtained from the data collected and recorded as control history by the Run-to-Run control system and by the Statistical Process Control (SPC) system. This information is available from databases 17, 27 as archived data.

Control processor 30 includes a group module 35 to analyze the collected information within databases 17, 27 and group controllers 20 in the manner described below. Control processor 30 is coupled to databases 17, 27 and/or control systems 15, 25 and retrieves information to perform the grouping analysis (e.g., R2R Data Flow and SPC Data Flow as viewed in FIG. 1A) according to embodiments of the present invention. The results of the grouping analysis (e.g., Controller Grouping[Ungrouping data as viewed in FIG. 1A) are provided to process controllers 20 of Run-to-Run control system 15 to enable those process controllers to function in the grouped (and/or ungrouped) manner according to the grouping analysis results.

Grouped process controllers generate controls for corresponding tools 10 in accordance with a control loop common to the group. In other words, grouped process controllers basically function as a single homogenous controller and generate common controls based on the same measured parameters, thereby reducing the quantity of control loops (or control processors) needed to perform the fabrication. Individual or ungrouped process controllers each basically utilize an exclusively associated control loop to generate controls for a corresponding tool 10 as described above. The group module is typically implemented by one or more software modules, but may be implemented by any quantity of any type of hardware (e.g., processor, circuitry, logic, etc.) and/or software modules distributed in any fashion among the Run-to-Run control system, Statistical Process Control system and/or control processor. In addition, the group module is preferably implemented via a rapid software development package, such as Visual Basic or Matlab, to extract and process the data. However, the group module may be implemented in any suitable computer language and/or by any conventional or other software development package.

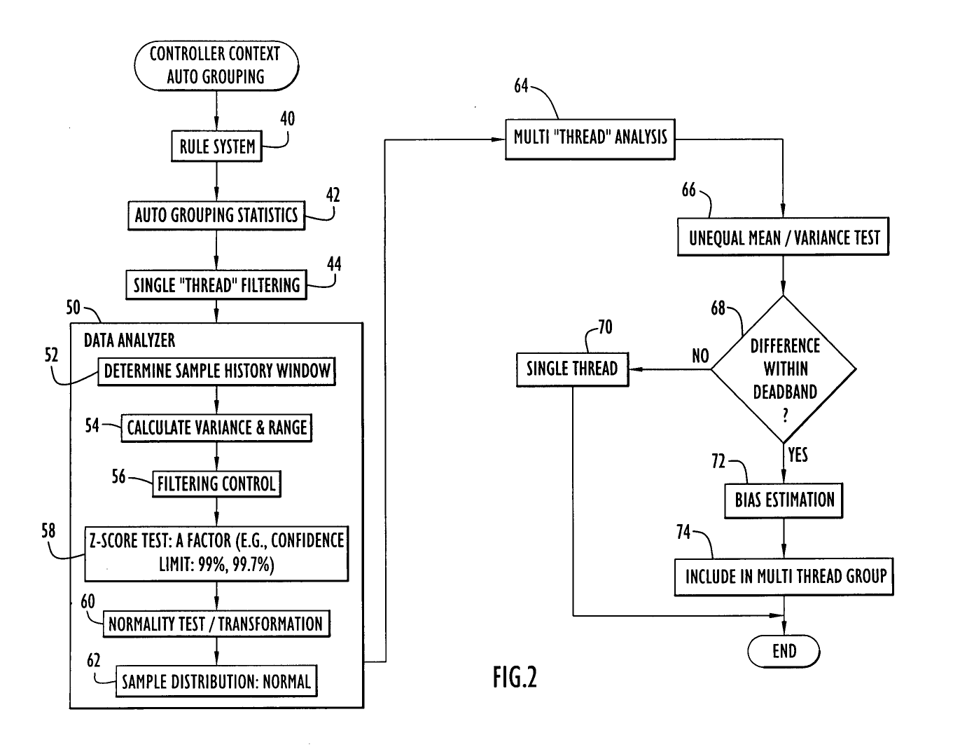

The manner in which control processor 30 groups process controllers 20 to reduce the quantity of control loops is illustrated in FIG. 2. Initially, the analysis for control loop compression or consolidation may be performed at various intervals and/or in response to any suitable conditions (e.g., in response to a manual activation by a user, at predetermined time intervals (e.g., every second, minute, ten minutes, fifteen minutes, etc.), prior to executing a fabrication process or run, prior to execution of a process stage, etc.). Specifically, a set of rules is determined for grouping the process controllers at step 40. The rule set is typically dependent upon the particular application and may be stored in a conventional storage unit (e.g., database, memory of control processor 30, etc.) for access by group module 35. The rule set may be based on any suitable conditions and/or information relating to the object, fabrication system and/or facility. The rule set basically defines processes, process controllers and corresponding behaviors (e.g., critical dimensions, overlay, focus, thickness, etc. with respect to a semiconductor fabrication process) to enable process controllers of similar types to be grouped. In addition, the rule set may provide the particular process parameters considered during, and/or various thresholds (e.g., deadband, bias, data validity, etc.) for, the grouping analysis to determine placement of process controllers within groups as described below.

The statistics or information utilized for the grouping analysis are determined at step 42. The statistics utilized are typically dependent upon the particular application and may be stored in a conventional storage unit (e.g., database, memory of control processor 30, etc.) for access by group module 35. The statistics may be based on any suitable information relating to the object, fabrication system and/or facility.

Once the rule set and statistics are determined, thread filtering is initiated at step 44. The rule set is utilized to initially determine threads (e.g., process controllers or control loops) that are eligible for placement in the same group. For example, threads corresponding to similar stages or tools of the fabrication process may be eligible for placement in the same group, while threads associated with unrelated stages or tools of the fabrication process are generally ineligible for placement in the same group.

When the threads eligible for grouping are identified, the appropriate data or information for each thread is analyzed at step 50. The analysis includes steps 52, 54, 56, 58, 60 and 62 as described below that determine the validity of the collected data for each thread and subsequently produce a normal distribution of valid thread data for the grouping analysis. The data or parameters (e.g., tool or other setting, object characteristic or materials, generated tool controls, dimensions, etc.) analyzed for each grouping analysis and/or thread may vary and are typically indicated by the rule set. For example, each parameter of a thread may be analyzed individually and compared to parameters of other threads to determine loop compression or consolidation. Alternatively, the parameters of a thread may be combined (e.g., by any suitable mathematical or other function or operation) to produce a single parameter value that is analyzed for that thread.

In particular, a sample window is determined for a thread at step 52. The sample window represents a prior time interval or history (e.g., previous day or days, previous week or weeks, etc.) of parameter data (collected by the Run-to-Run and Statistical Process Control systems) considered to be valid for a thread. The window interval is based on the particular application or process stage and is typically provided in the rule set. Generally, the more stable a particular process or thread, the smaller the window interval.

The variance and range of the thread data within the sample window are determined at step 54. These values may be determined via any conventional or other statistical techniques, and are generally utilized for the statistical tests described below. A filter is applied to the thread data at step 56. The filter characteristics are dependent upon a particular application and may be implemented by any conventional or other filtering techniques to provide a desired filtering effect. For example, the filter characteristics may correspond to a desired dampening effect for certain process stage characteristics. The filter basically enables prioritization or tweaking of the data for internal control.

Once the thread data is filtered, a Z-score test is applied to the filtered data at step 58 to determine the validity of the data. The test may be implemented by any conventional statistical techniques (e.g., Z-test, etc.), and basically determines whether the difference between the mean of a filtered data sample and the mean of the population is sufficient to be statistically different. The resulting Z-score value is a measure of the distance of the sample mean from the population mean and is typically translated into a percentage representing a confidence or validity value indicating the probability that the data is a valid sample. By way of example only, the test is preferably applied utilizing a standard deviation of three with a confidence value threshold of 99.7%. However, the test may be utilized with any suitable standard deviation and confidence value threshold. The data is considered valid in response to a predetermined percentage (e.g., 98%, etc.) of the data producing acceptable Z-score values (e.g., Z-scores indicating a confidence value in excess of the confidence threshold). If the test results indicate that the thread data is invalid for purposes of performing the grouping analysis, other data associated with the thread may be obtained (e.g., altering the sampling window, etc.) and the above analysis repeated. The above parameters for the test (e.g., confidence value and percentage thresholds, standard deviation, etc.) may be provided by the rule set and may be based on the particular application or thread being analyzed.

A normality test is applied to the filtered thread data at step 60. This test determines whether the data resides in a normal distribution (e.g., a Gaussian distribution or bell curve), and may be implemented by any conventional or other statistical techniques. If the thread data resides in a normal distribution, the resulting distribution for the thread is utilized for the grouping analysis at step 62. Otherwise, a transformation is applied to the data distribution at step 60 to attain a normal distribution for the thread at step 62. The transformation may be accomplished by any conventional or other statistical techniques. The normal distribution of the data enables comparison of the various parameters associated with the threads to determine grouping as described below.

Once the data is processed for each thread as described above, an analysis is initiated at step 64 to determine the particular threads (e.g., process controllers or control loops) eligible for grouping. Initially, a single thread is immediately placed into a group and successive threads are analyzed to determine the threads eligible for placement in the same group as the initial thread. In particular, an unequal mean/variance test is performed at step 66 to compare the processed data associated with threads in a group with processed data associated with a candidate thread under analysis. This test basically compares the mean of the particular data sets (e.g., group threads and candidate thread) and determines whether the data sets are statistically different. The test is preferably implemented by conventional statistical techniques (e.g., t-Test, Analysis of Variance (ANOVA), etc.). Results of the mean/variance test indicate differences between a group of threads and a candidate thread being analyzed for placement into that group.

A candidate thread is added to a group in response to the effects of the candidate thread on the corresponding process stage being insignificant under the common control loop of the group. This is ascertained by determining a predetermined range or deadband (e.g., in the form of a percentage or t-value range in the case of a t-Test) for a resulting value (e.g., indicating the differences between the candidate thread and group) produced by the mean/variance test. The deadband may vary depending upon the particular thread or associated information and is typically provided by the rule set. If the resulting value generated by the mean/variance test is outside the deadband as determined at step 68, this indicates that the candidate thread would have significant effects on the corresponding process stage under the common group control loop and, hence, is not added to the group at step 70.

On the other hand, when the resulting value generated by the mean/variance test is within the deadband as determined at step 68, this indicates that the candidate thread would have insignificant effects on the corresponding process stage under the common group control loop. Accordingly, a bias estimation is determined at step 72 and the candidate thread is added to the group at step 74. The bias indicates the degree of difference between the candidate thread and group. This value may be determined by any conventional statistical techniques (e.g., a t-Test value, etc.), and may be utilized for subsequent grouping analysis (e.g., threads within a certain bias, etc.) and/or to enhance accuracy of the candidate thread under the common group control loop (e.g., the bias may serve as a type of offset and be applied to the candidate thread during operation, etc.).

The mean/variance test may be performed for any quantity of individual parameters of the group threads and candidate thread, or for a representative value of the group threads and candidate thread (e.g., parameters mathematically or otherwise combined), where the candidate thread may be added to the group based on any quantity of the individual parameter test results, or the test results of the representative value, residing within the deadband. Further, the mean/variance test may be applied between a candidate thread and any quantity of threads within a group, or between a candidate thread and a combination of threads within the group (e.g., group threads may be combined in any fashion (e.g., averaging thread data, weighted sum of thread data, etc.)). Moreover, the mean/variance test may be iteratively applied to threads of a fabrication process to form one or more groups each with threads whose test results reside within the deadband.

Once the groupings have been determined, the results of the grouping analysis (e.g., Controller Grouping[Ungrouping data as viewed in FIG. 1A) are provided to process controllers 20 of Run-to-Run control system 15 to enable those process controllers to function in the grouped (and/or ungrouped) manner according to the grouping analysis results as described above. Alternatively, a single process controller may be utilized for each group of threads to control corresponding process stages in accordance with the common control loop of that group, or a single process controller may accommodate the resulting groups of threads to control corresponding process stages in accordance with the common control loops of the associated groups. In any event, the quantity of process controllers or control loops to perform the fabrication process is reduced by the present invention embodiments. In addition, the present invention embodiments may be utilized to analyze and reorganize or decompose existing groups in the manner described above in accordance with changing conditions or processes.

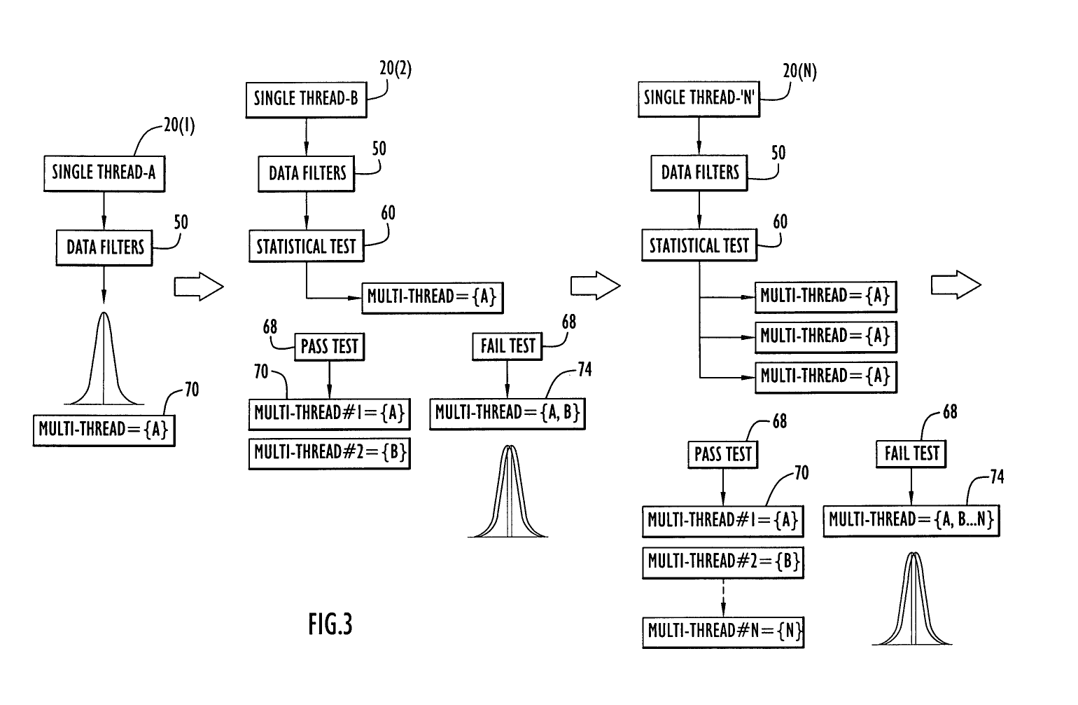

Operation of a present invention embodiment is described with reference to FIG. 3. Initially, a fabrication system includes a Run-to-Run control system 15 (FIG. 1A) with one or more process controllers 20 (FIG. 1B) each accommodating a control loop to control a corresponding tool 10. Control processor 30, via group module 35, analyzes desired threads (e.g., process controllers or control loops) of the fabrication process (e.g., threads 20(1)-20(N) as viewed in FIG. 3) to compress or consolidate the quantity of control loops or process controllers needed to perform the fabrication as described above. The analysis for control loop compression or consolidation may be performed at various intervals and/or in response to any suitable conditions (e.g., in response to a manual activation by a user, at predetermined time intervals (e.g., every second, minute, ten minutes, fifteen minutes, etc.), prior to executing a fabrication process or run, prior to execution of a process stage, etc.). Further, the compression analysis may be performed for any portion or the entirety of threads within a fabrication process.

Once the analysis is triggered, an initial thread 20(1) (e.g., Thread-A as viewed in FIG. 3) is processed by applying data filters 50 and associated statistical techniques (e.g., representing step 50 of FIG. 2) to produce a normal or Gaussian data distribution for that thread as described above. The initial thread is placed in a group 70 (e.g., Multi-Thread as viewed in FIG. 3; and representing step 70 of FIG. 2). A second thread 20(2) (e.g., Thread-B as viewed in FIG. 3) within the fabrication process is subsequently processed by applying data filters 50 and associated statistical techniques (e.g., representing step 50 of FIG. 2) to produce a normal or Gaussian data distribution for that thread as described above.

The data from threads 20(1) and 20(2) are compared by performance of a statistical test 60 (e.g., representing the unequal mean/variance test of step 60 in FIG. 2) as described above. If the statistical test indicates that the difference between the data of threads 20(1) and 20(2) is beyond a predetermined threshold range or deadband (e.g., representing step 68 of FIG. 2; and that the effects of thread 20(2) would be significant if placed under the common control loop of the group containing thread 20(1)), the threads are placed in separate or isolated groups 70 (e.g., Multi-Thread#1 and Multi-Thread#2 as viewed in FIG. 3; and representing step 70 of FIG. 2) as described above. However, if the statistical test indicates that the difference between the data of threads 20(1) and 20(2) is within a predetermined threshold range or deadband (e.g., representing step 68 of FIG. 2; and that the effects of thread 20(2) would be insignificant if placed under the common control loop of the group containing thread 20(1)), the threads are placed in the same group 74 (e.g., Multi-Thread as viewed in FIG. 3; and representing step 74 of FIG. 2) as described above.

The above process is repeated for the other threads (e.g., threads through 20(N)) within the fabrication process to determine placement of those threads in the group. For example, thread 20(N) (e.g., Thread-N as viewed in FIG. 3) within the fabrication process is subsequently processed by applying data filters 50 and associated statistical techniques (e.g., representing step 50 of FIG. 2) to produce a normal or Gaussian data distribution for that thread as described above.

The data from thread 20(N) and the threads within group 74 are compared by performance of a statistical test 60 (e.g., representing the unequal mean/variance test of step 60 in FIG. 2) as described above. If the statistical test indicates that the difference between the data of thread 20(N) and the group is beyond a predetermined threshold range or deadband (e.g., representing step 68 of FIG. 2; and that the effects of thread 20(N) would be significant if placed under the common control loop of the group), the thread is placed in a separate or isolated group 70 (e.g., Multi-Thread#N as viewed in FIG. 3; and representing step 70 of FIG. 2) as described above. However, if the statistical test indicates that the difference between the data of thread 20(N) and the group is within a predetermined threshold range or deadband (e.g., representing step 68 of FIG. 2; and that the effects of thread 20(N) would be insignificant if placed under the common control loop of the group), the threads are placed in the same group 74 (e.g., Multi-Thread as viewed in FIG. 3; and representing step 74 of FIG. 2) as described above.

By way of example only, FIG. 3 illustrates the analysis being performed in order to group threads 20(1)-20(N) in a common group (e.g., either place the threads in a common group or leave them as individual threads). However, the statistical test may be iteratively applied to threads 20(1)-20(N) to form one or more groups each with threads whose differences reside within the predetermined threshold range or deadband.

Once the groupings have been determined, the results of the grouping analysis are provided to process controllers 20 of Run-to-Run control system 15 to enable those process controllers to function in the grouped (and/or ungrouped) manner according to the grouping analysis results as described above. Alternatively, a single process controller may be utilized for each group of threads to control corresponding process stages in accordance with the common control loop of that group, or a single process controller may accommodate the resulting groups of threads to control corresponding process stages in accordance with the common control loops of the associated groups. In any event, the quantity of process controllers or control loops to perform the fabrication process is reduced.

The present invention embodiments provide several advantages. In particular, the present invention embodiments reduce the quantity of control loops to train and optimize, and provide increased flexibility for a fabrication facility to operate in a high part mix scenario. The grouping scheme of the present invention embodiments reduces the sampling needed for each product to attain optimal control and improves cycle time and process capability. In addition, the present invention embodiments provide a faster ramp of a product or part, while reducing the quantity of send ahead (SAHD) or precursor lots (e.g., quantities of products or materials) needed to train the process controllers prior to commencing actual fabrication.

It will be appreciated that the embodiments described above and illustrated in the drawings represent only a few of the many ways of implementing a method and apparatus for consolidating process control.

The fabrication system may include any quantity of process cells and may produce any types of products or components (e.g., semiconductor components, goods, etc.). The process cells may include any quantity of any type of conventional or other tools. The tools may perform any desired task within the manufacturing or fabrication process. The fabrication system may employ any suitable control and/or or monitoring system or scheme (e.g., Run-to-Run, Statistical Process Control, basic feedback loops, etc.). The fabrication system components (e.g., control systems, process cells, etc.) may be arranged in any fashion.

The Run-to-Run control system may be implemented by any conventional or other control system, and may include any quantity of controllers each controlling any quantity of tools and associated with any quantity of feedback or control loops. The controllers may generate control signals based on any desired feedback information (e.g., object characteristics, tool settings, measured conditions, etc.). The control system may employ any quantity of any suitable sensors or sensing devices to measure various conditions (e.g., tool settings or conditions, object characteristics, environmental conditions, etc.). The control system may collect and store any desired information (e.g., tool settings, tool controls, various fabrication system and/or environmental conditions, object characteristics, etc.). The database for the Run-to-Run control system may be implemented by any quantity of any conventional or other storage units (e.g., database, memory, data structure, file system, etc.). The controllers may be implemented by any quantity of any conventional or other computers or processing devices (e.g., controller, microprocessor, circuitry, logic, etc.).

The Statistical Process Control (SPC) system may be implemented by any conventional or other control or monitoring system and may include any quantity of processing systems (e.g., including displays, etc.). The SPC system may monitor, collect and/or store any desired information (e.g., tool settings, tool controls, various fabrication system and/or environmental conditions, object characteristics, etc.), and may provide this information to an operator in any desired fashion (e.g., reports, graphs, charts, etc.). The database for the SPC system may be implemented by any quantity of any conventional or other storage units (e.g., database, memory, data structure, file system, etc.).

The control processor may be implemented by any quantity of any conventional or other computers or processing devices (e.g., controller, microprocessor, circuitry, logic, etc.) and may be coupled to or communicate with the Run-to-Run control system, SPC system and/or their corresponding databases in any desired fashion (e.g., hard-wired, wireless, network, etc.). The group module may be implemented by any quantity of any type of hardware (e.g., processor, circuitry, logic, etc.) and/or software modules or units, and may be reside on, or be distributed in any fashion among, the Run-to-Run control system, Statistical Process Control system and/or control processor. The software (e.g., group module, etc.) for the present invention embodiments may be implemented in any suitable computer language and/or by any conventional or other software development package (e.g., Visual Basic, Matlab, etc.), and could be developed by one of ordinary skill in the computer and/or programming arts based on the functional description contained herein and the flow charts illustrated in the drawings. Further, any references herein of software performing various functions generally refer to processors performing those functions under software control. The software and/or algorithms described above and illustrated in the flow charts may be modified in any manner that accomplishes the functions described herein. The software of the present invention embodiments may be available on a recordable medium (e.g., magnetic or optical mediums, magneto-optic mediums, floppy diskettes, CD-ROM, DVD, memory devices, etc.) for use on stand-alone systems or systems connected by a network or other communications medium, and/or may be downloaded (e.g., in the form of carrier waves, packets, etc.) to systems via a network or other communications medium.

The grouping analysis may group threads (e.g., process controllers or control loops) in any desired fashion, where each group may include any quantity of any suitable threads. The analysis may utilize any desired information to group the threads (e.g., from the Run-to-Run system, from the SPC systems, any other information related to the system or object, etc.). The threads may be related to any aspect or stage of the fabrication process and may be grouped in any suitable fashion. The analysis may be triggered at various intervals and/or in response to any suitable conditions (e.g., in response to a manual activation by a user, at predetermined time intervals (e.g., every second, minute, ten minutes, fifteen minutes, etc.), prior to executing a fabrication process or run, prior to execution of a process stage, etc.). The rule set may include any quantity of any suitable rules in any desired format, and may be based on any suitable conditions and/or information relating to the object, fabrication system and/or facility. The rule set may be stored in any conventional or other storage structure (e.g., database, memory, file system, etc.) in any format or fashion. The sample window may include any desired prior time interval or history (e.g., previous day or days, previous week or weeks, etc.) of data. The interval may be from a user-specified prior time to the present, or may be a specified prior time interval range (e.g., data between first and second specified times, etc.).

The variance and range of the thread data may be determined via any conventional or other statistical techniques. The filter may be implemented by any conventional or other filtering techniques to provide a desired filtering effect. The Z-score test may be implemented by any conventional statistical techniques (e.g., Z-test, etc.). The test may be utilized with any suitable standard deviation, confidence value threshold and validity threshold (e.g., percentage of data satisfying the confidence value). The normality test and transformation may be implemented by any conventional or other statistical techniques. The grouping analysis may employ any other suitable distribution and/or transformation for the data. The mean/variance test may be implemented by any conventional statistical techniques (e.g., t-Test, Analysis of Variance (ANOVA), etc.). The deadband or other thresholds may be set to any suitable ranges to indicate differences between the data, and typically vary depending upon the particular thread or associated information. The Z-score and mean/variance tests may configured to produce values indicating the data is valid or statistically different, or values indicating the inverse of these (e.g., data is invalid or statistically the same).

The bias value may be determined by any conventional statistical techniques (e.g., a t-Test value, etc.). The bias value may be utilized for subsequent grouping analysis (e.g., accommodating more or less stringent requirements by grouping threads within a certain bias range, etc.) and/or to enhance accuracy of a candidate thread under the common group control loop (e.g., the bias may serve as a type of offset and be applied to the candidate thread during operation to produce enhanced control, etc.).

The grouping analysis may be performed for any quantity of any individual parameters of the threads, or for any quantity of representative values of the threads (e.g., each representative value resulting from any quantity of any of the thread parameters being mathematically or otherwise combined), where a candidate thread may be added to a group based on any quantity of the individual parameter or representative value test results satisfying the analysis (e.g., residing within the deadband of the mean/variance test). Further, the analysis may be applied between a candidate thread and any quantity of threads within a group, or between a candidate thread and a combination of threads within the group (e.g., group threads may be combined in any fashion (e.g., averaging thread data, weighted sum of thread data, etc.)). Moreover, the analysis may be iteratively applied to threads to form one or more groups each with threads whose test results satisfy the analysis (e.g., reside within the deadband of the mean/variance test).

The results of the grouping analysis may include any desired information (e.g., controls, group indications, indications for each thread, etc.) and may be provided to the Run-to-Run control system in any fashion. The process controllers may interpret the grouping information to function in the grouped (and/or ungrouped) manner according to the grouping analysis results. Alternatively, a single process controller may be utilized for each group of threads to control corresponding process stages in accordance with the common control loop of that group, or a single process controller may accommodate the resulting groups of threads to control corresponding process stages in accordance with the common control loops of the associated groups. Further, the analysis may be utilized to analyze and reorganize or decompose existing groups in the manner described above in accordance with changing conditions or processes.

The present invention embodiments are not limited to the applications described above (e.g., semiconductor fabrication, etc.), but may be utilized in substantially the same manner described above to reduce control loops (or control processors) within with any fabrication, manufacturing or other system employing plural control or feedback loops to perform a process.

From the foregoing description, it will be appreciated that the invention makes available a novel method and apparatus for consolidating process control, wherein process controllers of a semiconductor fabrication process are monitored and dynamically grouped and/or ungrouped based on a model/rule schema to consolidate process control (e.g., reduce the quantity of control loops or process controllers within the fabrication process).

Having described preferred embodiments of a new and improved method and apparatus for consolidating process control, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A system for consolidating process control for a process comprising a plurality of control threads each associated with a stage of said process comprising:
a processing system to analyze a plurality of said control threads to enable said process control with a reduced quantity of said control threads, said processing system comprising:
a data analysis module to validate data associated with said plurality of said control threads and to provide said data in a desired form; and
a group analysis module to statistically analyze at least one parameter of each of said plurality of said control threads and to form at least one thread group comprising a plurality of said control threads satisfying said parameter analysis, wherein each thread group functions as a common thread to enable said process control with a reduced quantity of said control threads.

2. The system of claim 1, wherein said data analysis module comprises:
a statistics module to determine a variance and range of data sampled within a specified time interval and associated with said plurality of said control threads;
a filter module to apply a filtering characteristic to said sampled data;
a validity module to apply a statistical test to said filtered data using information from said variance and range values to determine validity of said sampled data; and
a distribution module to determine the presence of said filtered data in a particular distribution representing said desired form and to transform said filtered data into said particular distribution in response to said filtered data being distributed in a manner different than said particular distribution.

3. The system of claim 2, wherein said statistical test comprises a Z-test and said particular distribution comprises a normal distribution.

4. The system of claim 1, wherein said group module comprises:
a comparison module to apply a statistical test to compare said at least one parameter of said plurality of said control threads;
a bias module to determine a bias value for control threads satisfying said statistical test; and
a group module to form at least one thread group each comprising corresponding ones of said control threads satisfying said statistical test.

5. The system of claim 4, wherein said comparison module applies said statistical test by determining a difference between at least one of a mean and variance of said at least one thread parameter of said plurality of said control threads and comparing said difference to a threshold value to determine eligibility of said control threads for placement within a thread group.

6. The system of claim 1, wherein said process comprises a semiconductor fabrication process and said process control comprises a Run-to-Run control system and a Statistical Process control system each collecting information during said process control, wherein said data analysis module ascertains said data associated with said plurality of said control threads from said collected information.

7. A system for consolidating process control for a process comprising a plurality of control threads each associated with a stage of said process comprising:
processing means for analyzing a plurality of said control threads to enable said process control with a reduced quantity of said control threads, said processing means comprising:
data analysis means for validating data associated with said plurality of said control threads and providing said data in a desired form; and
group analysis means for statistically analyzing at least one parameter of each of said plurality of said control threads and forming at least one thread group comprising a plurality of said control threads satisfying said parameter analysis, wherein each thread group functions as a common thread to enable said process control with a reduced quantity of said control threads.

8. The system of claim 7, wherein said data analysis means comprises:
statistics means for determining variance and range values for data sampled within a specified time interval and associated with said plurality of said control threads;
filter means for applying a filtering characteristic to said sampled data;
validity means for applying a statistical test to said filtered data using information from said range and variance values to determine validity of said sampled data; and
distribution means for determining the presence of said filtered data in a particular distribution representing said desired form and transforming said filtered data into said particular distribution in response to said filtered data being distributed in a manner different than said particular distribution.

9. The system of claim 8, wherein said statistical test comprises a Z-test and said particular distribution comprises a normal distribution.

10. The system of claim 7, wherein said group means comprises:
comparison means for applying a statistical test to compare said at least one parameter of said plurality of said control threads;
bias means for determining a bias value for control threads satisfying said statistical test; and
group means for forming at least one thread group each comprising corresponding ones of said control threads satisfying said statistical test.

11. The system of claim 10, wherein said comparison means applies said statistical test by determining a difference between at least one of a mean and variance of said at least one thread parameter of said plurality of said control threads and comparing said difference to a threshold value to determine eligibility of said control threads for placement within a thread group.

12. The system of claim 7, wherein said process comprises a semiconductor fabrication process and said process control comprises a Run-to-Run control system and a Statistical Process control system each collecting information during said process control, wherein said data analysis means ascertains said data associated with said plurality of said control threads from said collected information.

13. A program product apparatus comprising a computer readable medium with computer program logic recorded thereon for consolidating process control for a process comprising a plurality of control threads each associated with a stage of said process, said apparatus comprising:
a data analysis module to validate data associated with said plurality of said control threads and to provide said data in a desired form; and
a group analysis module to statistically analyze at least one parameter of each of said plurality of said control threads and to form at least one thread group comprising a plurality of said control threads satisfying said parameter analysis, wherein each thread group functions as a common thread to enable said process control with a reduced quantity of said control threads.

14. The apparatus of claim 13, wherein said data analysis module comprises:
a statistics module to determine a variance and range of data sampled within a specified time interval and associated with said plurality of said control threads;
a filter module to apply a filtering characteristic to said sampled data;
a validity module to apply a statistical test to said filtered data using information from said variance and range values to determine validity of said sampled data; and
a distribution module to determine the presence of said filtered data in a particular distribution representing said desired form and to transform said filtered data into said particular distribution in response to said filtered data being distributed in a manner different than said particular distribution.

15. The apparatus of claim 14, wherein said statistical test comprises a Z-test and said particular distribution comprises a normal distribution.

16. The apparatus of claim 13, wherein said group module comprises:
a comparison module to apply a statistical test to compare said at least one parameter of said plurality of said control threads;
a bias module to determine a bias value for control threads satisfying said statistical test; and
a group module to form at least one thread group each comprising corresponding ones of said control threads satisfying said statistical test.

17. The apparatus of claim 16, wherein said comparison module applies said statistical test by determining a difference between at least one of a mean and variance of said at least one thread parameter of said plurality of said control threads and comparing said difference to a threshold value to determine eligibility of said control threads for placement within a thread group.

18. The apparatus of claim 13, wherein said process comprises a semiconductor fabrication process and said process control comprises a Run-to-Run control system and a Statistical Process control system each collecting information during said process control, wherein said data analysis module ascertains said data associated with said plurality of said control threads from said collected information.

19. A method of consolidating process control for a process comprising a plurality of control threads each associated with a stage of said process comprising:
(a) validating data associated with said plurality of said control threads and providing said data in a desired form; and
(b) statistically analyzing at least one parameter of each of said plurality of said control threads and forming at least one thread group comprising a plurality of said control threads satisfying said parameter analysis, wherein each thread group functions as a common thread to enable said process control with a reduced quantity of said control threads.

20. The method of claim 19, wherein step (a) comprises:
(a.1) determining a variance and range of data sampled within a specified time interval and associated with said plurality of said control threads;
(a.2) apply a filtering characteristic to said sampled data;
(a.3) applying a statistical test to said filtered data using information from said variance and range values to determine validity of said sampled data; and
(a.4) determining the presence of said filtered data in a particular distribution representing said desired form and transforming said filtered data into said particular distribution in response to said filtered data being distributed in a manner different than said particular distribution.

21. The method of claim 20, wherein said statistical test comprises a Z-test and said particular distribution comprises a normal distribution.

22. The method of claim 19, wherein step (b) further comprises:
(b.1) applying a statistical test to compare said at least one parameter of said plurality of said control threads;
(b.2) determining a bias value for control threads satisfying said statistical test; and
(b.3) forming at least one thread group each comprising corresponding ones of said control threads satisfying said statistical test.

23. The method of claim 22, wherein step (b.1) comprises:
(b.1.1) determining a difference between at least one of a mean and variance of said at least one thread parameter of said plurality of said control threads and comparing said difference to a threshold value to determine eligibility of said control threads for placement within a thread group.

24. The method of claim 19, wherein said process comprises a semiconductor fabrication process and said process control comprises a Run-to-Run control system and a Statistical Process control system each collecting information during said process control, wherein step (a) comprises:
(a.1) ascertaining said data associated with said plurality of said control threads from said collected information.
